(19) United States
(12) Patent Application Publication
(10) Pub. No.: US 2022/0193924 A1
(43) Pub. Date: Jun. 23, 2022

(54) ROBOT END EFFECTOR

(71) Applicant: SAFEMACHINES, PLLC, Austin, TX (US)

(72) Inventor: RICHARD HOOPER, Austin, TX (US)

(21) Appl. No.: 17/130,455

(22) Filed: Dec. 22, 2020

(51) Int. Cl. B25J 15/00; B25J 15/06

(52) U.S. Cl. CPC B25J 15/0071; B25J 15/02; B25J 15/0608; B25J 15/0052

(57) ABSTRACT

A robot end effector includes a stationary plate having at least one stabbing pin extending therefrom and an ejector plate, adjacent to the stationary plate, having a at least one aperture through which the at least one stabbing pin extends. An actuator assembly comprising an actuator coupled to an ejector post via a linkage assembly advances and retracts the ejector post through a support, the ejector post extending through an aperture in the stationary plate and having a distal end coupled to the ejector plate. The ejector post increases separation of the ejector plate from the stationary plate when the ejector post is advanced through the support.

### BACKGROUND

Robotic systems are used in a variety of industries to perform mechanical functions, especially repetitive tasks which may require a high degree of precision. A robotic device such as an articulating robotic manipulator may be equipped with an end effector for enabling the robotic device to perform a particular function. One function that may be performed by a robotic system is a so-called “pick-and-place” operation in which the robotic system picks up an item at a first physical location and places it in a second physical location.

### BRIEF DESCRIPTION OF THE DRAWINGS

The present disclosure is best understood from the following detailed description when read with the accompanying figures, wherein:

FIG. 1A is a side view of a stabbing assembly according to one or more examples with an ejector plate in a retracted position;

FIG. 1B is a side view of the stabbing assembly of FIG. 1A with the ejector plate in an advanced position;

FIG. 2A is a bottom view of the ejector plate in the stabbing assembly of FIGS. 1A and 1B;

FIG. 2B is a bottom view of a stationary plate in the stabbing assembly of FIGS. 1A and 1B;

FIG. 2C is a bottom view of both the ejector plate and the stationary plate in the stabbing assembly of FIGS. 1A and 1B;

FIG. 2D is a top view of the stationary plate in the stabbing assembly of FIGS. 1A and 1B;

FIG. 3 is an isometric view of the stabbing assembly of FIGS. 1A and 1B;

FIG. 4A is a side view of a robot end effector according to one or more examples, the side view including a stabbing plate of a stabbing assembly in a retracted position;

FIG. 4B is a side view of the robot end effector of FIG. 4A with the stabbing plate of the stabbing assembly in an advanced position;

FIG. 5A is a top view of the robot end effector of FIGS. 4A and 4B;

FIG. 5B is a bottom view of the robot end effector of FIGS. 4A and 4B;

FIG. 5C is a bottom view of the robot end effector of FIGS. 4A and 4B with the stabbing assemblies removed;

FIG. 6 is a side view of a robot end effector according to one or more additional examples;

FIG. 7 is a side view of a robot manipulator according to one or more examples;

FIG. 8 is a side view of the robot manipulator of FIG. 7 having a robot end effector according to one or more examples attached to a tool plate thereof;

FIGS. 9A, 9B, and 9C are side views of a robot end effector according to one or more examples at different phases of a pick-and-place operation that includes stabbing and releasing items.

It is emphasized that, in accordance with the standard practice in the industry, various features are not drawn to scale. In fact, the dimensions of the various features may be arbitrarily increased or reduced for clarity of discussion or illustration.

### DETAILED DESCRIPTION

Illustrative examples of the subject matter claimed below are disclosed. In the interest of clarity, not all features of an actual implementation are described for every example implementation of this specification. It will be appreciated that in the development of any such actual implementation, numerous implementation-specific decisions may be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

Further, as used herein, the article “a” is intended to have its ordinary meaning in the patent arts, namely “one or more.” Herein, the term “about” when applied to a value generally means within the tolerance range of the equipment used to produce the value, or in some examples, means plus or minus 10%, or plus or minus 5%, or plus or minus 1%, unless otherwise expressly specified. Further, herein the term “substantially” as used herein means a majority, or almost all, or all, or an amount with a range of about 51% to about 100%, for example. Moreover, examples herein are intended to be illustrative only and are presented for discussion purposes and not by way of limitation.

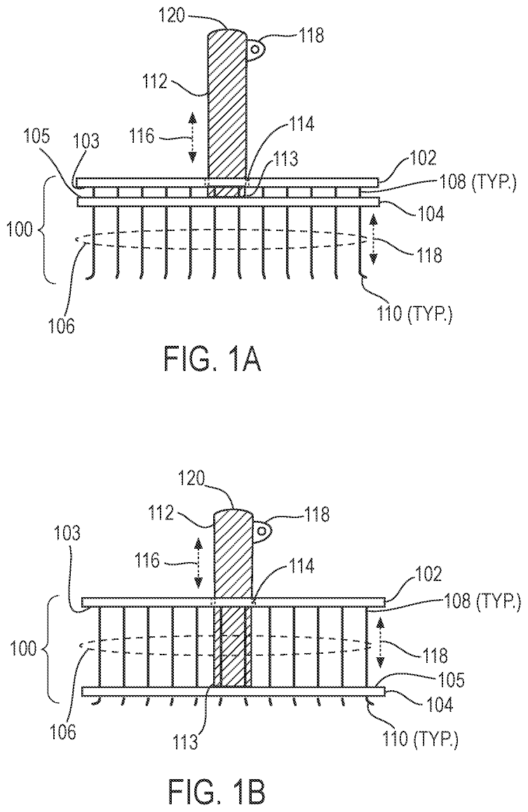

FIGS. 1A and 1B illustrate side views of a stabbing assembly 100 for a robot end effector according to one or more examples. Stabbing assembly 100 comprises a stationary plate 102 and an ejector plate 104. Stationary plate 102 includes a plurality of stabbing pins 106 each having a proximal end 108 extending from a bottom surface 103 of stationary plate 102 and a free distal end 110. Each stabbing pin 106 extends through an aperture in ejector plate 104 (as hereinafter shown and described).

Also shown in FIGS. 1A and 1B is an ejector post 112 which extends through an opening 114 in stationary plate 102 and is coupled at a distal end 113 to ejector plate 104 such that when ejector post 112 advances and retracts in the direction shown by arrows 116 in FIGS. 1A and 1B, ejector plate 104 is advanced and retracted relative to stationary plate 102 as represented by arrows 116. In the retracted position of ejector post 112 and ejector plate 104 shown in FIG. 1A, ejector plate 104 is situated relatively nearer to proximal end 108 of stabbing pins 106. Alternatively, while in the advanced position of ejector post 112 and ejector plate 104 shown in FIG. 1B, the distance between stationary plate 102 and ejector plate 104 is increased such that ejector plate 104 is situated relatively nearer to distal ends 110 of stabbing pins 106, i.e., an increased distance away from the stationary plate. In some examples, distal ends 110 of stabbing pins 106 may be curved, as shown in FIGS. 1A and 1B, to facilitate engagement and retention of an item by stabbing pins 106 when an item is stabbed by stabbing pins 106, as hereinafter described.

In various examples, ejector post 112 may comprise an elongate (e.g., cylindrical) magnet which is magnetically coupled at distal end 113 to a rear face 105 of ejector plate 104. Also, in various examples, ejector post 112 includes an actuator coupling 118 at a proximal end 120 thereof for coupling ejector post 112 to an actuator as hereinafter described.

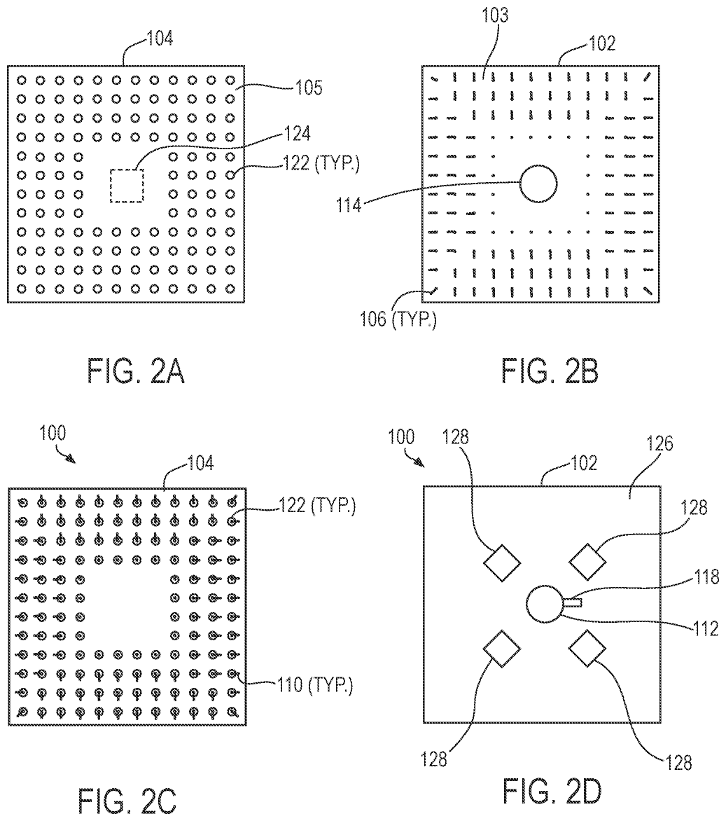

FIG. 2A is a top view of top surface 105 of ejector plate 104 from the examples of FIGS. 1A and 1B. As shown in FIG. 2A, ejector plate 104 includes a plurality of apertures 122 therein positioned to receive a corresponding stabbing pin 106 extending from stationary plate 102. In various examples, ejector plate 104 may be made of a magnetically attractive metal, to facilitate magnetic coupling of ejector plate 104 to ejector post 112. In other examples, ejector plate 104 may be provided with a magnetically attractive element on upper surfaced 105, as represented by dashed outline 124 in FIG. 2A, for facilitating magnetic coupling of ejector plate 104 to ejector post 112.

FIG. 2B is a bottom view of stationary plate 102 from the examples of FIGS. 1A and 1B. In this example, aperture 114 in stationary plate 102 is centrally located on stationary plate to allow ejector post 112 (not shown in FIG. 2B) to extend therethrough. As shown, a plurality of stabbing pins 106 extend from the bottom surface 103 of stationary plate 102.

FIG. 2C is a bottom view of stabbing assembly 100 from the example of FIGS. 1A and 1B. FIG. 2C shows distal ends 110 of stabbing pins 106 extending through respective corresponding apertures 122 in ejector plate 104. FIG. 2D is a top view of stabbing assembly 100 from the example of FIGS. 1A and 1B, including the top surface 126 of stationary plate 102. Also shown in FIG. 2D is ejector post 112 with actuator coupling 118.

In some examples, and as shown in FIG. 2D, a plurality of magnets 128 may be disposed on upper surface 126 of stationary plate 102. Magnets 128 may facilitate attachment and orientation of stabbing assembly 100 to an end effector housing, as hereinafter described. In other examples, magnetically attractive metal on the upper surface 126 of stationary plate 102 may be used to facilitate attachment and orientation of stabbing assembly 100 to the end effector housing.

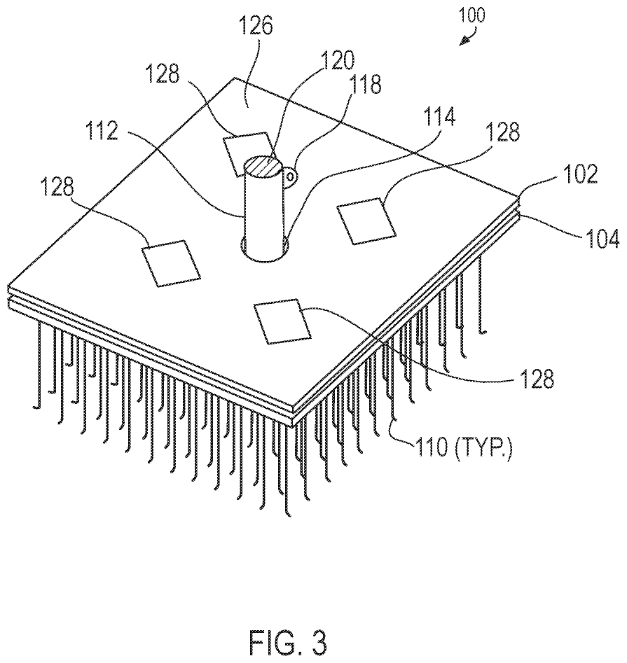

FIG. 3 is an isometric view of stabbing assembly 100 from the example of FIGS. 1A and 1B, along with ejector post 112. In FIG. 3, stabbing assembly 100 is shown with ejector plate 104 in its retracted position relative to stationary plate 102.

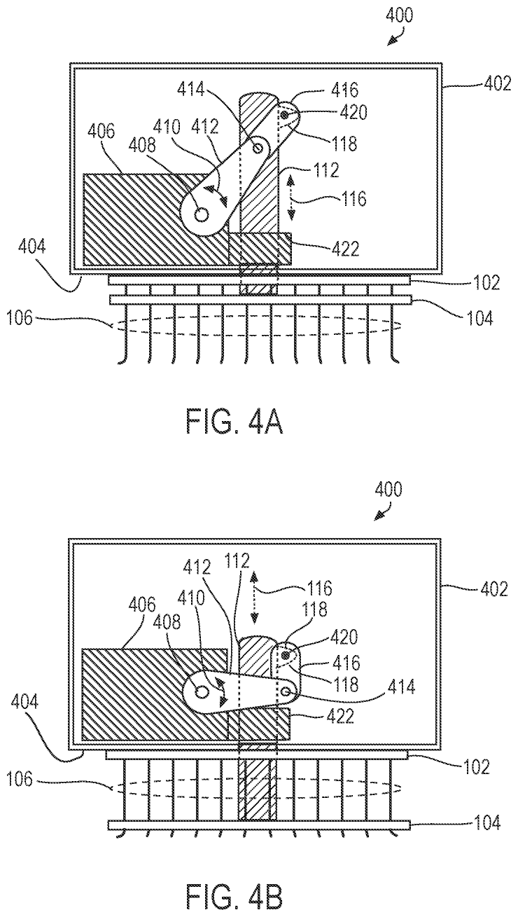

Turning to FIGS. 4A and 4B, there are shown side cross-sectional views of a robot end effector 400 incorporating the stabbing assembly 100 and ejector post 112 substantially according to the examples of FIGS. 1A and 1B. As shown in FIGS. 4A and 4B, robot end effector 400 includes an end effector housing 402. In some examples, housing 402 may be made of a rigid plastic material. In various examples, top surface 126 of stationary plate 102 is coupled to a bottom surface 404 of housing 402. Coupling of stationary plate 102 to bottom surface 404 of effector housing 402 may be facilitated by magnets 128 or magnetically attractive metal on upper surface 126 of stationary plate 102, as previously described with reference to FIGS. 2D and 3, and a plurality of magnets (not shown in FIGS. 4A and 4B) on bottom surface 404 of effector housing 402.

The magnetic coupling of ejector post 112 to ejector plate 104 in various examples herein likewise minimizes the need for other types of mechanical fasteners or structures. This may facilitate the cleaning and sanitization of stabbing assemblies 100, which, because of the magnetic coupling, may be easily removed from an effector housing for cleaning.

It is to be noted that the coupling of stationary plate 102 to bottom surface 404 of housing 402 using magnets advantageously reduces or eliminates the need for other types of mechanical connectors and structures. In some examples, this may render housing 402 easier to clean and less susceptible to retaining debris which might otherwise accumulate during operation of robot end effector 400. This may be beneficial in applications such as food preparation, where stabbing pins 106 are utilized to engage food items, such as slices of bread, tomatoes, cheese, and the like.

With continued reference to FIGS. 4A and 4B, ejector post 112 extends through bottom surface 404 into the interior of effector housing 402. Supported within housing 402 is a rotary actuator 406. In various examples, rotary actuator 406 may be a servomotor capable of controlled rotation of a drive post 408 in the directions indicated by arrow 410 in FIGS. 4A and 4B.

In the example of FIGS. 4A and 4B, linkage elements 412 and 416 are coupled between drive post 408 and actuator coupling 118 of ejector post 112. In particular, in this example, linkage element 412 is coupled at one end to drive post 408 of actuator 406 and at a hinge point 414 to one end of second linkage element 416. Another end of linkage element 416 is coupled with a pin 420 to actuator coupling 118 of ejector post 112. With this arrangement, rotation of drive post 408 of actuator 406 in the directions of arrow 410 is translated into up-and-down motion of ejector post 112, as represented by arrow 116 in FIGS. 1A and 1B, and FIGS. 4A and 4B. FIG. 4A shows ejector post 112 and ejector plate 104 in their retracted positions, while FIG. 4B shows ejector post 112 and ejector plate 104 in their advanced positions.

In some examples, actuator 406 may include a guide structure 422 through which ejector post 112 extends. Guide structure 422 may support and guide ejector post 112 during its up-and-down motion.

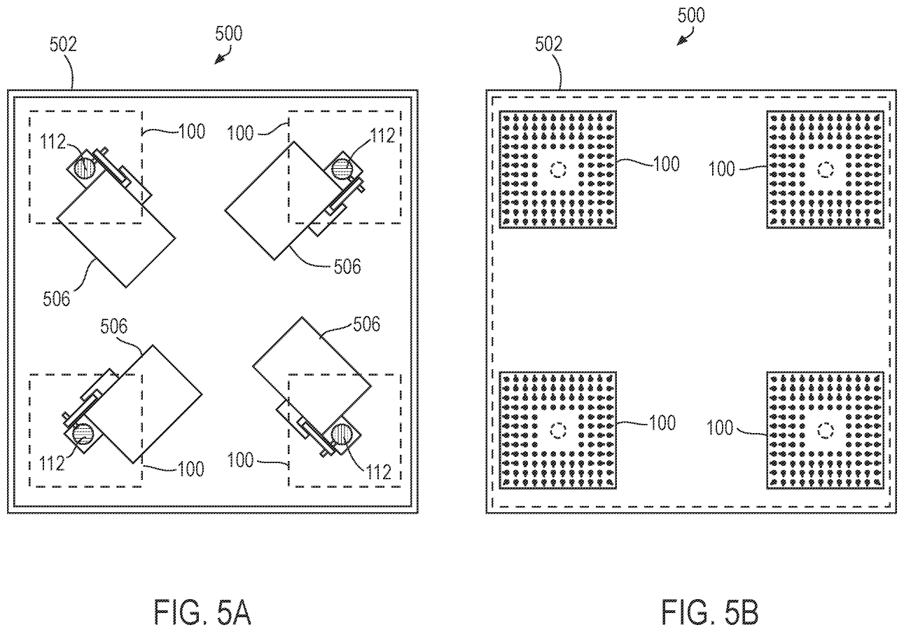

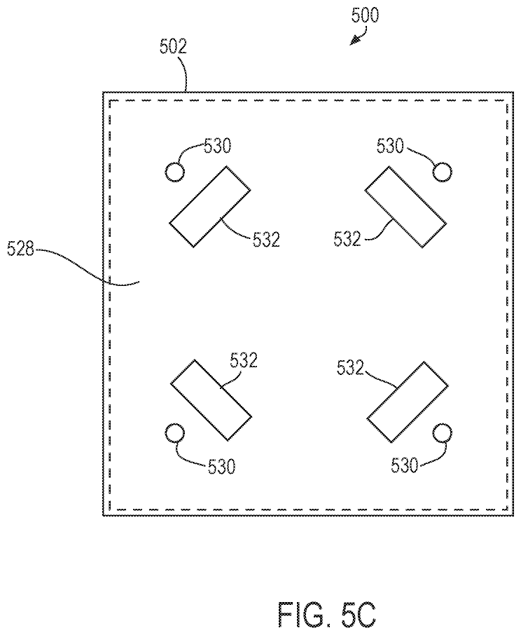

Referring to FIGS. 5A-C, in some examples, a plurality of actuators and stabbing assemblies may be incorporated into a single robot end effector. FIG. 5A is a top, cross-sectional view of a robot end effector 500 having a housing 502 supporting four actuators 506. In this example, each actuator is associated with a separate ejector post coupled to a separate stabbing assembly 100. FIG. 5B is a bottom view of robot end effector 500 from the example of FIG. 5A.

FIG. 5C is a bottom view of the robot end effector 500 from the examples of FIGS. 5A and 5B without stabbing assemblies 100 being attached thereto. As shown in FIG. 5C, a bottom surface 528 of effector housing 502 has a plurality of holes 530 therethrough for allowing ejector posts 112 (not shown) to extend to actuate stabbing assemblies 100. In the example of FIG. 5C, a plurality of magnets 532 may be disposed on bottom surface 528 of effector housing 502 in order to facilitate attachment of stabbing assemblies 100 by attraction to magnets 128 or magnetically attractive metal thereon, as previously described with reference to FIG. 2D. the arrangement of magnets 128 on stabbing assemblies 100 and magnets 532 on bottom surface 528 of effector housing 502 may further facilitate a desired orientation of stabbing assemblies 100, such as the orientation shown in FIG. 5B.

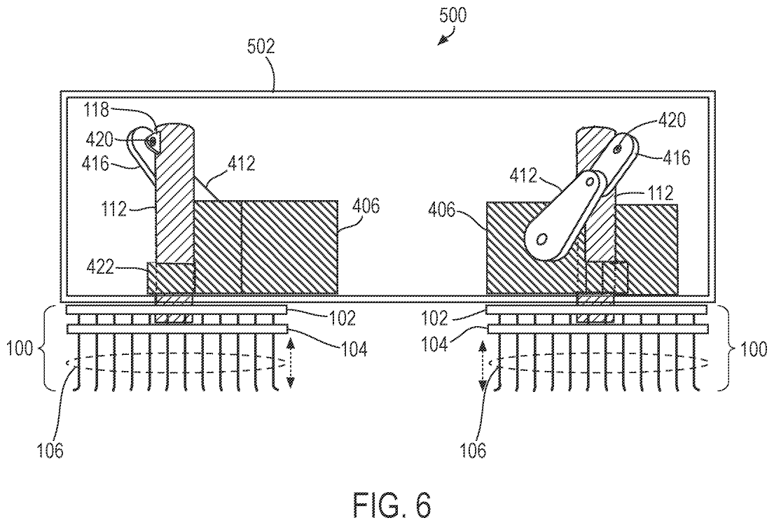

FIG. 6 is a side, cross-sectional view of robot end effector from the examples of FIGS. 5A-5C.

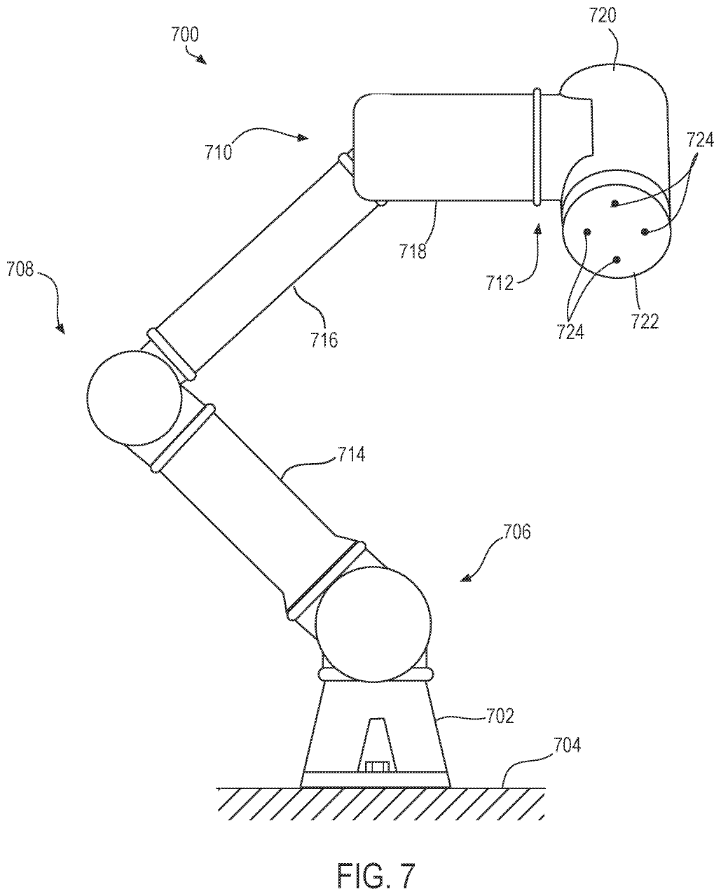

FIG. 7 is a side view of a robot manipulator 700 with which a robot end effector according to one or more examples herein may be utilized. In the example of FIG. 7, robot manipulator 700 includes a base 702 adapted to be mounted to an operating surface 704. Robot manipulator 700 may include a plurality of articulating joint sections 706, 708, 710, 712 connected between a plurality of interconnecting segments 714, 716, 718. In this example, articulating joint 712 connects an interconnecting segment 718 to a tool head 720 having a tool plate 722.

The arrangement of articulating joint sections 706, 608, 210, 712 and interconnecting segments 714, 716, 718 provides a high degree of freedom of motion of tool head 720, such that with appropriate articulation, tool head 720 may be located and oriented in any position within the physical dimensions of robot manipulator 700. A plurality of threaded connector holes 724 may be provided on tool plate 722 for attachment of various robot end effectors, providing desired functionality of robot manipulator 700.

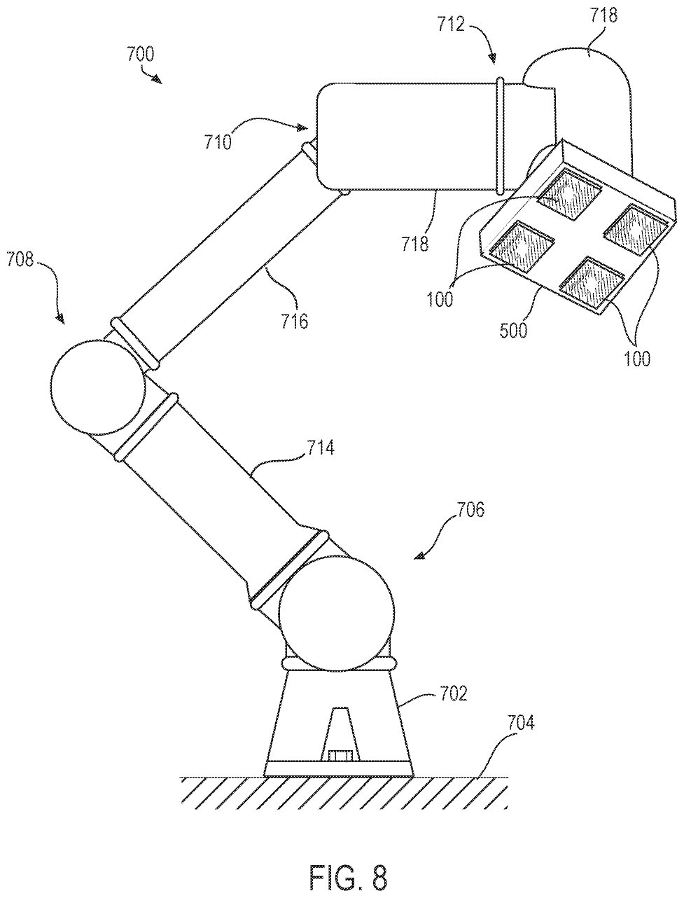

FIG. 8 is a side view of robot manipulator 700 after being equipped with robot end effector 500 from the example of FIGS. 5A-5C and 6. As shown in FIG. 8, robot end effector 500 may be attached to tool plate 722 of robot manipulator 700, enabling robot manipulator 700 to manipulate robot end effector 500 into various positions. Robot end effector 500 may thereby enable robot manipulator 700 to perform pick-and-place operations on items susceptible to being engaged by stabbing pins 106.

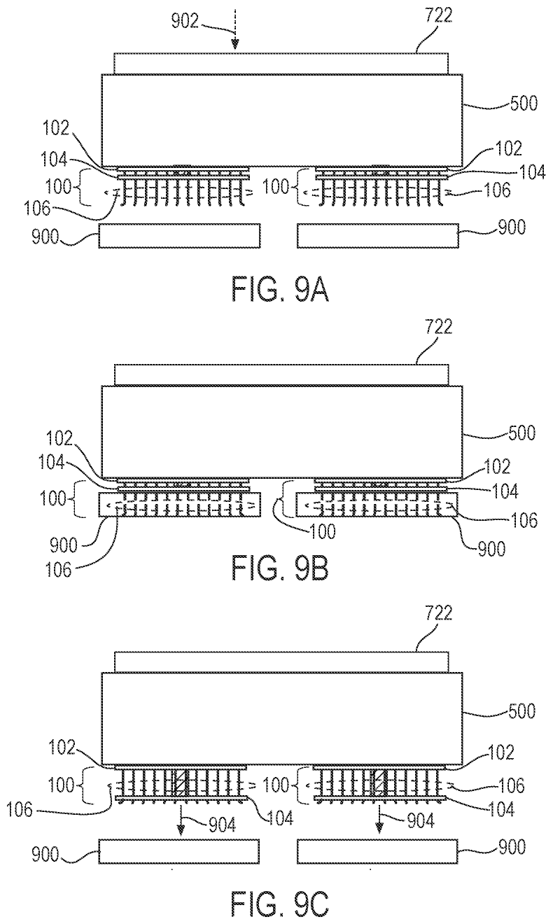

FIGS. 9A-9C depict a pick-and-place operation performed using a robot end effector such as robot end effector 500 from the example of FIGS. 5A-5C and 6. As shown in FIGS. 9A-9C, robot end effector 500 may be attached to tool plate 722 of robot manipulator 700. In a first stage (or phase) of a pick-and-place operation, robot manipulator 700 orients robot end effector 500 above one or more items 900 to be moved. As previously noted, items 900 may be any items susceptible to being stabbed by stabbing pins 106 of stabbing assemblies 100. Such items include food items, such as tomato slices, bread slices, cheese slices, pickle slices, and so on.

As shown in FIG. 9A, robot manipulator drives robot end effector 400 downward onto items 900, as indicated by arrow 902 in FIG. 9A. This causes stabbing pins 106 to stab and engage items 900, as shown in FIG. 9B. Robot manipulator 700 may then move and re-orient robot end effector 500 to a desired location, carrying items 900 along with robot end effector 500.

Next, as shown in FIG. 9C, robot end effector 500 may eject items 900 by advancing ejector plate 104 away from stationary plate to release items 900 off of stabbing pins 106. Items 900 may drop as indicated by arrows 904 in FIG. 9C.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific examples are presented for purposes of illustration and description. They are not intended to be exhaustive of or to limit this disclosure to the precise forms described. Many modifications and variations are possible in view of the above teachings. The examples are shown and described in order to best explain the principles of this disclosure and practical applications, to thereby enable others skilled in the art to best utilize this disclosure and various examples with various modifications as are suited to the particular use contemplated. It is intended that the scope of this disclosure be defined by the claims and their equivalents below.

What is claimed is:

1. A robot end effector, comprising:
a stationary plate having at least one stabbing pin extending therefrom;
an ejector plate, adjacent to the stationary plate and having at least one first aperture through which the at least one stabbing pin extends; and
an actuator assembly comprising:
an ejector post; and
an actuator coupled to the ejector post via a linkage assembly for advancing and retracting the ejector post through a support, the ejector post extending through a second aperture in the stationary plate and having a distal end coupled to the ejector plate, the ejector post increasing separation of the ejector plate from the stationary plate when the ejector post is advanced through the support.

2. The robot end effector of claim 1, further comprising:
a housing for containing the actuator assembly, the housing having a third aperture in a bottom surface thereof through which the ejector post extends.

3. The robot end effector of claim 2, wherein the stationary plate is attached to the bottom surface of the housing.

4. The robot end effector of claim 3, wherein the stationary plate is magnetically attached to the bottom surface of the housing.

5. The robot end effector of claim 4, wherein the distal end of the ejector post is magnetically coupled to the ejector plate.

6. The robot end effector of claim 5, wherein the ejector post comprises a magnet.

7. The robot end effector of claim 2, wherein in a top surface of the housing is adapted for attachment to a tool plate of a robotic manipulator.

8. The robot end effector of claim 1, wherein the at least one stabbing pin further comprises a plurality of stabbing pins, each of the stabbing pins being curved at the distal end thereof.

9. The robot end effector of claim 1, wherein the actuator comprises a servo motor.

10. A stabbing assembly for a robot end effector, the stabbing assembly comprising:
a stationary plate having at least one stabbing pin extending therefrom;
an ejector plate, adjacent to the stationary plate and having a at least one aperture through which the at least one stabbing pin extends, the ejector plate to advance from a retracted position relatively nearer to the stationary plate to an advanced position relatively nearer to a distal end of the at least one stabbing pin;
wherein the stabbing assembly is adapted to engage an item by stabbing the item with the at least one stabbing pin while the ejector plate is in the retracted position and to release the item responsive to the ejector plate advancing to the advanced position.

11. The stabbing assembly of claim 10, wherein the at least one stabbing pin further comprises a plurality of stabbing pins, each of the stabbing pins being curved at the distal end thereof.

12. The stabbing assembly of claim 10, wherein the stationary plate is adapted for attachment to a robot end effector housing.

13. The stabbing assembly of claim 12, wherein the ejector plate is advanced to the advanced position by an ejector post extending from the robot end effector housing.

14. The stabbing assembly of claim 13, wherein the stationary plate is adapted for magnetic attachment to the robot end effector housing, and the ejector plate is adapted for magnetic attachment to the ejector post.

15. A method of performing a pick-and-place operation, the method comprising:
providing a stationary plate having at least one stabbing pin extending therefrom;
providing an ejector plate adjacent to the stationary plate and having at least one aperture through which the at least one stabbing pin extends;
stabbing an item with the at least one stabbing pin to engage the item on the at least one stabbing pin;
advancing the ejector plate along the at least one stabbing pin and away from the stationary plate to effect a release of the item from the at least one stabbing pin.

16. The method of claim 15, wherein advancing the ejector along the at least one stabbing pin and away from the stationary plate comprises advancing the ejector plate away from the stationary plate by advancing an ejector post extending through the stationary plate.

17. The method of claim 16, further comprising retracting the ejector plate toward the stationary plate following a release of the item from the at least one stabbing pin.

18. The method of claim 17, wherein retracting the ejector plate toward the stationary plate following the release of the item comprises retracting the ejector post.

19. The method of claim 18, further comprising magnetically coupling the ejector post to the ejector plate.

20. The method of claim 15, further comprising magnetically coupling the stationary plate to a robot arm end effector housing.
